(19) United States
(12) Patent Application Publication
(10) Pub. No.: US 2003/0219094 A1
(43) Pub. Date: Nov. 27, 2003

(54) Excimer or molecular fluorine laser system with multiple discharge units

(76) Inventors: Dirk L. Basting, Ft. Lauderdale, FL (US); Sergei V. Govorkov, Boca Raton, FL (US)

Correspondence Address: STALLMAN & POLLOCK LLP, Attn: Brian J. Keating, Suite 290, 121 Spear Street, San Francisco, CA, 94105, US

(21) Appl. No.: 10/440,730

(22) Filed: May 19, 2003

Related U.S. Application Data
(60) Provisional application No. 60/382,490, filed on May 21, 2002.
(60) Provisional application No. 60/399,797, filed on Jul. 30, 2002.
(60) Provisional application No. 60/419,176, filed on Oct. 15, 2002.

(51) Int. Cl. G21K 5/00

(52) U.S. Cl. 378/34

(57) ABSTRACT

A sub-310 nm lithography radiation source includes first and second beam generating modules for generating first and second pulsed beams, a beam combiner optic for producing a single combined beam from the first and second pulsed beams, and optics for directing each of the first and second pulsed beams to be incident upon the beam combiner.

### PRIORITY CLAIM

The present application claims priority to U.S. Provisional Patent Application Serial Nos. 60/382,490, filed May 21, 2002, and 60/399,797, filed Jul. 30, 2002, and 60/419,176 filed Oct. 15, 2002, the disclosures of which are incorporated herein by reference.

### BACKGROUND

1. Field of the Invention

The invention provides an excimer or molecular fluorine laser, or an EUV generating source, with two or more discharge or pulse generating modules, where the output beams of multiple modules are combined spatially, and/or temporally, into a single output beam.

2. Description of the Related Art

Line narrowed excimer lasers are applied in the art of photolithography for production of integrated circuits. Achromatic imaging optics for this wavelength region are difficult to produce. For this reason line-narrowed excimer laser radiation is used for photolithography in order to prevent errors caused by chromatic aberration. Typical, acceptable bandwidths for different imaging systems are tabulated in Table 1 for the excimer and molecular fluorine laser wavelengths 248 nm (KrF), 193 nm (ArF), and 157 nm (F₂):

TABLE 1

| | | | | |
|---|---|---|---|---|
| imaging optics | 248 nm | 193 nm | 157 | nm |
| refractive optics | 0.4 pm-0.6 pm | 0.3 pm-0.6 pm | 0.1 | pm |
| catadioptrics | 20-100 pm | 10-40 pm | ≈1 | pm |

Current lithography lasers operate at pulse repetition rates up to 2-4 kHz. It is desired to have a lithography laser that operates at more than 4 kHz, such as 6, 8 or 10 kHz or more, to increase the throughput of the lithographic process. One approach would be to design a laser discharge unit that may be reliably operated at pulse repetition rates of 6 kHz and above. Such a system with increased repetition rate would exhibit an averaged power in the laser cavity that would rise by a factor, e.g., 2-5 times or more. This would entail an increased thermal load on intracavity optical components, and particularly on narrow band optics. A comparatively high thermal load on the optical components may be connected with the special discharge design advantageous for high repetition rates. This design may be characterized by, e.g., very narrow discharge electrodes. Narrow discharge electrodes have the advantage of low pulse energy fluctuations at very high repetition rates. However, narrow electrodes are connected with high power densities in the resonator. The present invention avoids the described difficulties relating to increased thermal load on intracavity optics due to increased pulse repetition rate.

### BRIEF DESCRIPTION OF THE DRAWINGS

FIG. 1a is a schematic diagram illustrating two laser modules and associated optics for combining the outputs of the modules into a single output.

FIG. 1b is a schematic diagram of a suitable beam combiner.

FIG. 2 is a schematic diagram of an alternate form of a beam combiner.

FIGS. 3a and 3b are schematic diagrams of further alternate forms of a beam combiner.

FIGS. 4a and 4b are schematic diagrams of further alternate forms of a beam combiner.

FIG. 5 illustrates the divergence of the laser output as it travels from a beam combiner.

FIG. 6a is a schematic diagram of an alternate discharge circuit arrangement using a common solid state switch.

FIG. 6b is a schematic diagram of an alternate discharge circuit arrangement using a pair of solid state switches.

FIGS. 7a, 7b and 7c illustrate an approach for combining beams in a manner to increase the width of the profile of the beam.

FIGS. 8a, 8b and 8c illustrate an alternate approach for combining beams in a manner to increase the width of the profile of the beam.

FIG. 9 is a schematic diagram of a laser module of the type suitable for use in the subject invention.

FIGS. 10a and 10b is a schematic diagram of an alternate form of beam combiner which includes an AO modulator.

### DESCRIPTION OF THE INVENTION

Systems and methods are provided for combining at least two pulsed excimer or molecular fluorine laser beams from different lasers to obtain a composite beam having a higher power than any of the individual lasers. The peak power may be increased by overlapping the pulses, or the repetition rate may be increased by resolving the pulses, or a combination of both. For example, a pair of 4 kHz lasers may be used for emitting a pair of 4 kHz beams that are combined to form a combined 8 kHz beam or a combined 4 kHz beam having twice the power of each of the two original 4 kHz beams. The at least two beams impinge a beam combining optic or beam combining optics, hereinafter referred to as the beam combiner.

The beam combiner is configured to combine the at least two beams emitted from the at least two lasers that are each incident from different directions into a composite beam, i.e., combined to be directed along a substantially common optical path. The two beams are synchronized so that the individual pulses of the combined beam have a selected temporal spacing such that they are resolved, overlapped or partially-resolved and/or partially-overlapped, anywhere from temporally evenly-spaced to completely temporally overlapped. An internal trigger unit preferably triggers the discharge units of the at least two lasers.

The wavelengths and energies of the pulses of the combined beam are also preferably controlled by diagnostic components such as a beam splitter, energy and/or wavelength detection equipment, a processor, etc., such that the combined beam exhibits high wavelength and pulse energy and/or energy dose stability. A common diagnostic control unit may be used for monitoring the wavelength and energy of the combined beam and for signaling control units of the respective lasers to control the input energies and wavelength tuning optics accordingly.

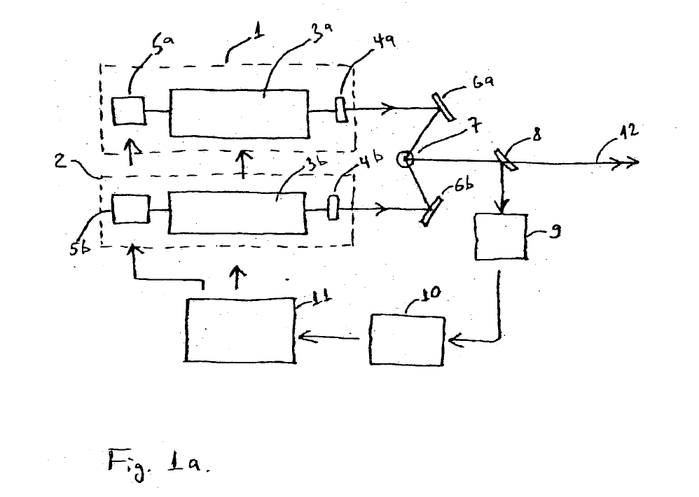

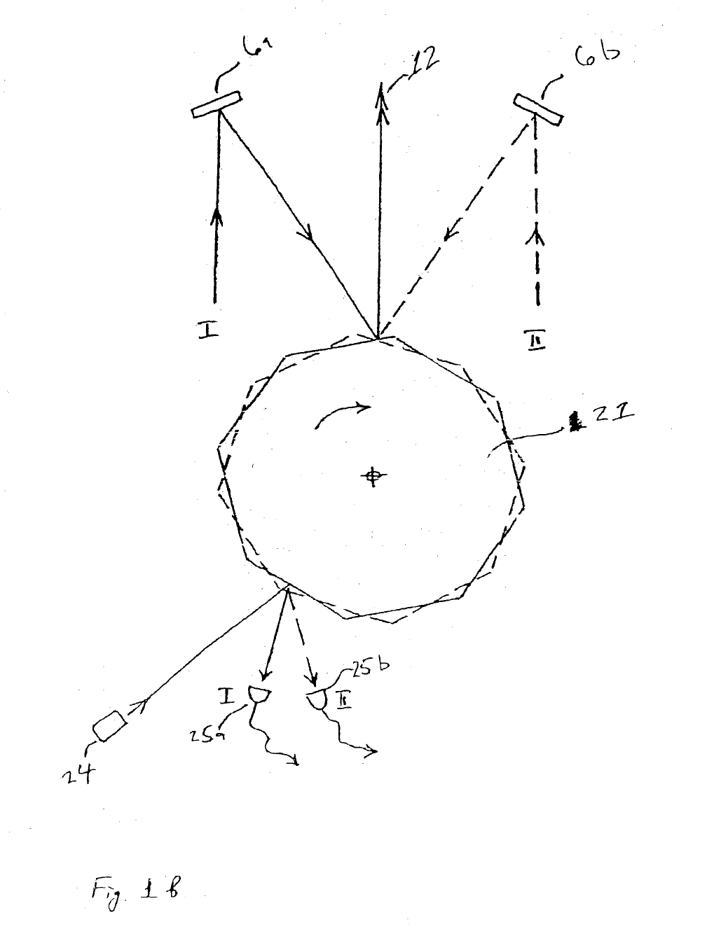

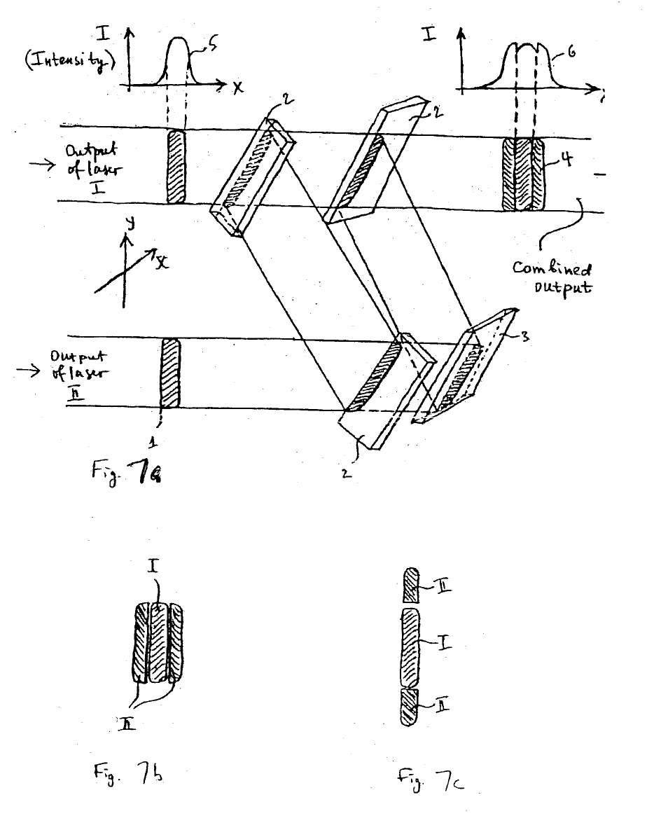

The general layout of the proposed system is illustrated schematically in FIG. 1a. Here, two laser modules 1 and 2 are combined in the system. Note, however, that three or more units can be combined, as well. Each module 1 and 2 preferably includes a discharge chamber 3a, 3b with a set of main and preionization electrodes, circulation fan, heat exchanger, pulser module and dust precipitator (each not shown, but see FIG. 7 and corresponding description below), a high voltage power supply 11 (may be shared), optical resonator including preferably an output coupling mirror 4a, 4b and a rear optics module 5a, 5b which serves for line selection and/or line-narrowing, and means of monitoring beam characteristics (pulse energy, spectral intensity distribution, spatial profile, temporal profile, and/or ASE, etc.), and electronic controls for stabilizing and adjusting the parameters of the output beam, which may be generally shared such as beam splitter 8, beam parameter monitor 9, processor 10, and feedback control loop schematically illustrated at FIG. 1a. Many further modifications of the individual laser modules 1 and 2 are possible as described below with reference to FIG. 7, as described in references incorporated by reference herein and/or as may be otherwise understood by those skilled in the art.

The output beams of each of the modules 1 and 2 are directed using steering mirrors 6a and 6b, respectively, onto the beam combiner 7, which is described in more detail below, thus producing a single output beam 12. At least one beamsplitter 8 splits a portion of the output beam into the diagnostic module 9, to monitor output pulse energy and/or wavelength spectrum, and/or other laser beam parameter(s). Real-time data relating to these laser beam characteristics are fed into the computer 10 which, in turn, may adjusts the pump power of the high voltage power supply 11, controls the spectrally selective modules 5a, 5b, initiate gas actions using a gas replenishment module (not shown, etc.).

The preferred system serves to combine the beams by interleaving the two trains of pulses, where one train is delayed with respect to the other by approximately one-half of the pulse period. This effectively doubles the pulse repetition rate of the output beam. At the same time, since the diagnostic module 9 is capable of resolving each individual pulse, it generates data on the output of each individual laser module. Therefore, this approach reduces the cost of the system, by eliminating the need for two separate diagnostic modules for each laser module.

Alternatively, if for some reason increased repetition rate is undesirable or if higher peak intensities are desired, it is possible to synchronize the laser modules so that the pulses overlap. Some synchronization techniques for oscillator-amplifier systems that may be used in a preferred embodiment are described at U.S. Pat. No. 6,381,256 and references cited therein, and U.S. patent application Ser. Nos. 09/858,147, 09/923,770, 60/346,781 and 60/309,939, which are assigned to the same assignee as the present application, each being hereby incorporated by reference. The synchronization accuracy requirements for the oscillator-amplifier system are greater than for the system of the preferred embodiment. This is particularly because, for an oscillator-amplifier system, the precision of the synchronization directly affects the pulse-to-pulse energy stability.

FIG. 1b schematically illustrates a beam combiner 21 according to a first embodiment. The beam combiner 21 of FIG. 1b includes an optical scanner component 21 upon which the beams from the laser modules 1 and 2 of FIG. 1a are reflected from the beam steering mirrors 6a, 6b, respectively. The scanner 21 includes preferably a cylinder with multiple flat facets machined on its sides. Each facet is preferably thin-film coated to provide high reflectivity for the laser beams. Similar scanning equipment may be found, e.g., at conventional supermarket check-out registers. The laser pulses are synchronized to the rotational angle of the scanner in such a way that the direction of the reflected beam 12 of the laser module 1 (shown by solid line) coincides with the direction of reflected beam 2 (corresponding scanner wheel position is shown by dashed line). Steering mirrors 6a, 6b help to overlap the beams spatially, while temporal synchronization defines the output beam direction and degree of overlap, if any, of the two beams combined into output beam 12. The fact that the rotating cylinder has multiple reflecting surfaces helps to reduce required revolution frequency of the scanner wheel. One possible way of synchronizing the scanner and the laser pulses is to monitor an angular position of the wheel by means of a small pilot laser 24 preferably emitting a beam incident upon the scanner 21 from another direction than the beams from the laser modules 1 and 2. The laser 24 may be a diode laser, HeNe laser, split-off portion of one of the lasers 1, 2, etc. Two photodiodes 25a and 25b generate electrical pulse when the wheel reaches a certain angle. Each of these two diodes can be used for triggering the corresponding laser module 1,2. An external trigger may be synchronized with signals from the diodes 25a and 25b to control the timing of the pulses of the beam 12 at an application process.

The desired precision of synchronization can be estimated as follows. Lets assume that each laser 1, 2 runs at 4 kHz, and the wheel has 64 facets. This means that the rotational speed of the wheel has to be at least 3750 RPM, while the angular speed is at least 393 rad/sec. This means that synchronization within 100 ns will provide pointing stability of 80 micro-radians. At the same time, 100 ns precision is far easier to achieve than, e.g., 10 ns precision such as may be required for an oscillator-amplifier system depending on the energy stability requirements of the application process with which it used. Increasing the number of facets will further relax the requirement for the synchronization precision.

The embodiment of FIG. 1b can be used to combine outputs of more than two lasers. In such case, the system will preferably further include additional steering mirrors 6c, 6d, etc., and detectors 25c, 25d, etc.

Non-exhaustive advantages of the beam combiner 21 of the system of FIG. 1b include that the contributions from laser modules 1 and 2 of the combined beam 12 arrive at the stepper at the same angle and position so as not to detract from image quality. In addition, the combined beam 12 may be effectively polarized.

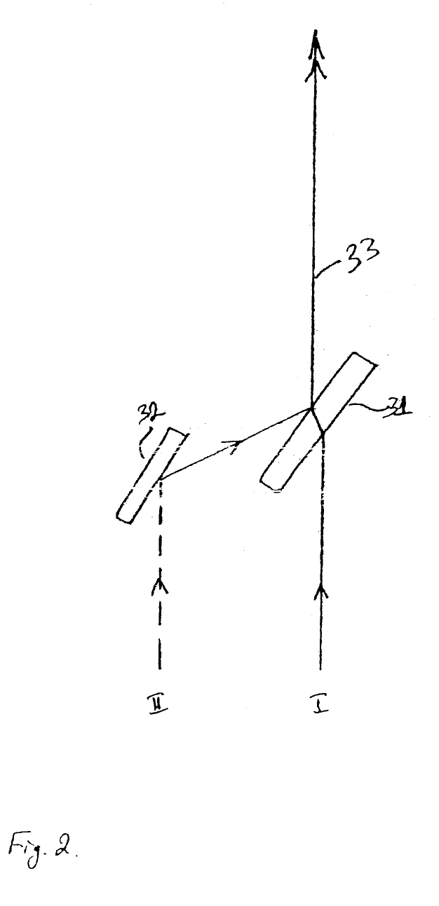

FIG. 2 schematically illustrates a beam combiner 31 according to another embodiment. The beam combiner 31 includes a polarizer 31. The polarizer 31 is preferably a thin-film polarizer and preferably transmits nearly 100% of the beam from laser module 1 (of FIG. 1a) which itself may be p-polarized with respect to the polarizer/beam combiner 31. At the same time, the polarizer/beam combiner 31 reflects nearly 100% of the beam from laser module 2, which may itself be s-polarized. Steering mirror 32 serves to overlap the two beams spatially and angularly, in order to produce the combined output beam 33. In this embodiment, preferably both lasers have linearly polarized output. To rotate the polarization of one of the lasers, one can use a waveplate made of a suitable birefringent material such as MgF₂ or crystalline quartz, or another polarization rotator known to those skilled in the art.

Non-exhaustive advantages of the beam combiner 31 of the system of FIG. 2 include that the contributions from laser modules 1 and 2 of the combined beam 33 arrive at the stepper at the same angle and position so as not to detract from image quality. Also, the beam combiner 31 and steering mirror 32 are mechanically simple as involving no moving parts during operation (i.e., once the steering mirror is initially or periodically adjusted.

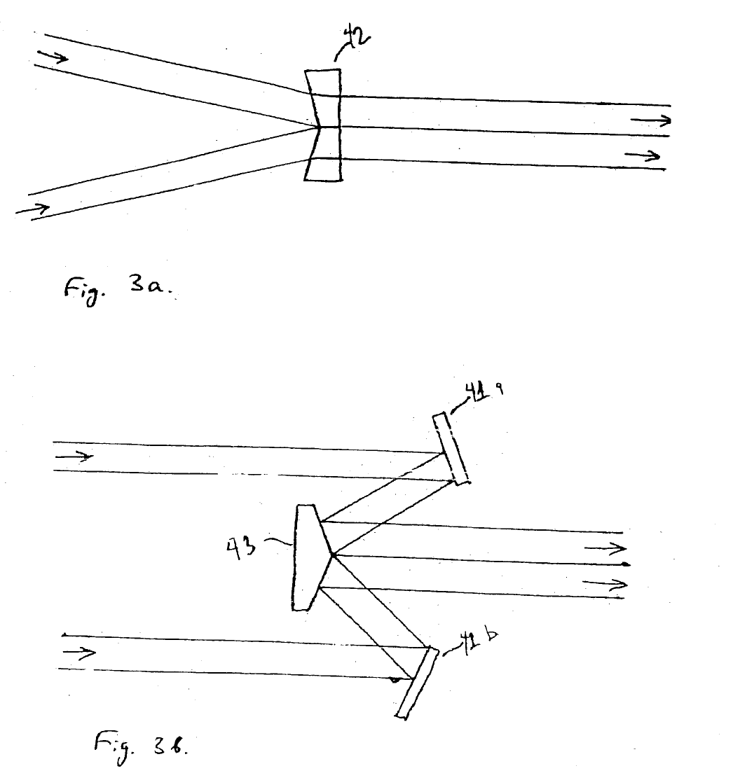

Further beam combiners according to further embodiments are schematically illustrated at FIGS. 3a and 3b. The embodiment of FIG. 3a may or may not use any beam steering mirrors, whereas the embodiment of FIG. 3b preferably uses beam steering mirrors 41a and 41b. The beam combiner 42 of FIG. 3a is a refractive bi-prismatic element 42, while the beam combiner 43 of the embodiment of FIG. 3b includes a pair of reflecting surfaces. In each case, the beams from the laser modules 1 and 2 (of FIG. 1a) are made to propagate side-by-side in the same direction. Such “stitching” of the beams can be done by the combination of steering mirrors 41a, 41b and the mirror surfaces of element 43 of FIG. 3b or using the bi-prism 42 of FIG. 3a.

The output beam properties of the embodiments of FIGS. 3a and 3b will show a discontinuity in the middle, where the “stitching” occurs. For example, the spatial coherence radius of an excimer laser beam is typically several hundred micrometers or some fraction of a millimeter. However, at the “stitching” boundary, the spatial correlation is broken. This may result in reduced beam homogenization and subsequent mask imaging, because spatial coherence is typically carefully controlled in the stepper to avoid optical speckle effects. However, due to the effects of beam divergency, caused by diffraction and also natural wavefront curvature inherent in excimer lasers, which can be enhanced, if desired, by providing an additional negative lens preferably after the beam combiner element 42 and/or 43, the stitching boundary will only be substantially present in the near field.

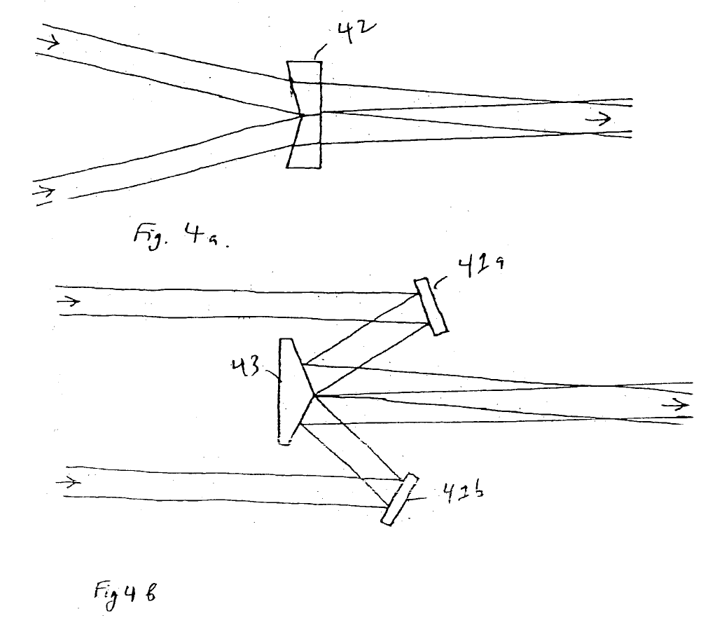

Further embodiments are set forth at FIGS. 4a and 4b and include the same general beam combiner components 41a, 41b, 42 and 43 as described above with reference to FIGS. 3a and 3b, although beam incidence angles and/or angles of the bi-prism 42 or reflecting surfaces of component 43 may differ. The combined beams of FIGS. 4a and 4b are spatially overlapped in contrast to the combined beams shown in FIGS. 3a and 3b. The spatial overlap occurs while the beams from laser modules 1 and 2 are propagated at a small angle to each other. Again, this is achieved by suitable steering mirrors 41am 41b, 43 and prisms 42.

Non-exhaustive advantages of the beam combiners 42, 43 of the systems of FIGS. 3a, 3b, 4a and 4b include that the combined beam may be effectively polarized. Also, the beam combiner 42 and beam combiner 43 and steering mirrors 41a, 41b are mechanically simple as involving no moving parts during operation (i.e., once the steering mirrors are initially and/or periodically adjusted).

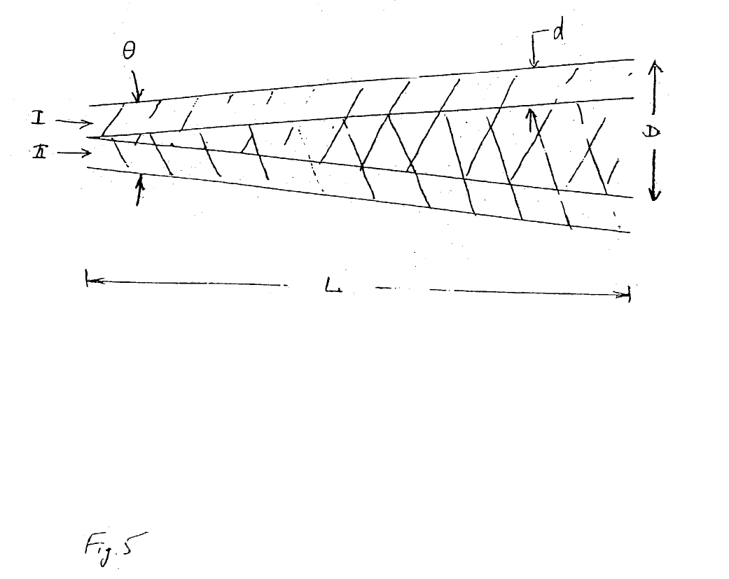

FIG. 5 shows that at a distance L from the laser output, i.e., from the beam combiner element 42 and/or 43, the beam width becomes roughly D=d+L·Q, where Q is the full divergence angle of the beam, and d is the beam width at the laser output. The beam separation remains roughly equal to d. Therefore, the overlapped relative portion of the beam is approximately equal to L·Q/(L·Q+2d), and increases in the far field. For example, assuming an initial beam width of d=2 mm and a divergency of 1.5 mrad, at 5 meters from the laser, the overlapped portion of the beam cross section is 65%. This means that the intensity distribution of the resulting beam resembles that of a diffracted, single beam, since each beam is “bell”-shaped.

Another consideration is the effect of beam propagation on the relative phases of the beams. In the far field, each beam's wavefront is effectively tilted with respect to the other by an angle roughly equal to d/L. Therefore, at greater distances, this tilt is decreased, which is equivalent to having a single wavefront, or a single beam. Also, the two (or more) beams are each produced by different lasers and, therefore, there will tend to be no interference effects between the two beams. This is very similar again to the effect of a single beam with double repetition rate, since each pulse in the beam is independent in phase from another.

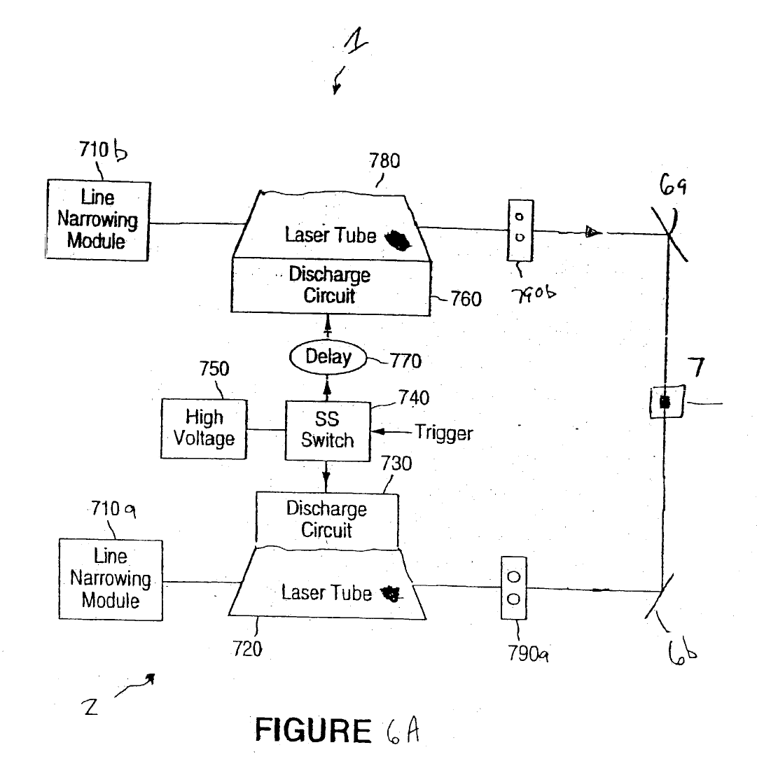

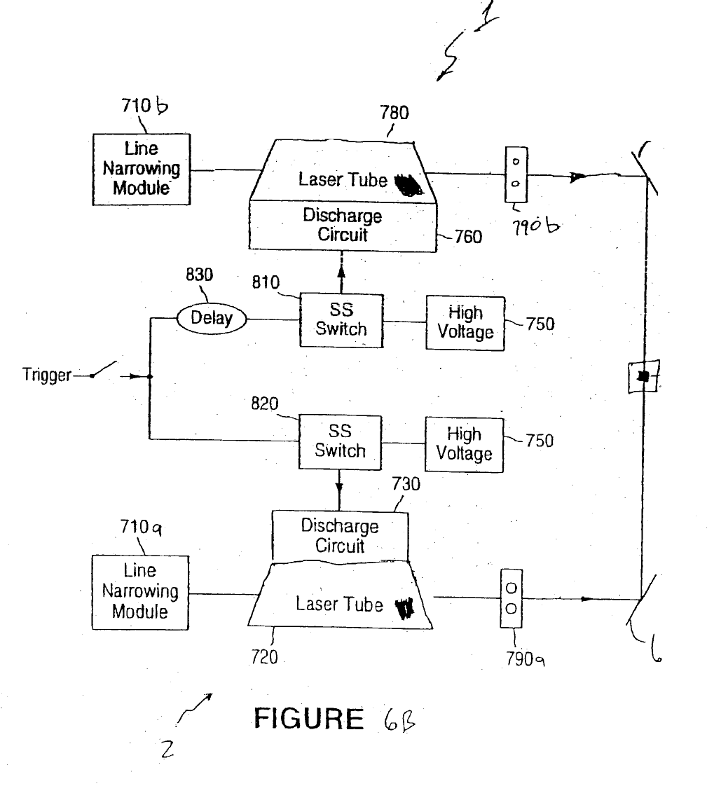

FIG. 6A schematically illustrates an alternate discharge circuit arrangement in accordance with a variation of the preferred embodiments set forth herein. Referring to FIG. 6A, the laser modules 1 and 2 include a resonator including a line-narrowing and/or selection module 710a,b, and laser tube 720, 780 and an output coupler 790a,b. The laser modules 1,2 may be configured as described elsewhere herein such as with reference to FIG. 7, below, other than as described herein for combining together.

Laser modules 1 and 2 further include a discharge circuit 730, 760 and pulse compressor as described with reference to FIG. 7. The discharge circuit 730, 760 may include configurations as shown and described in any of U.S. Pat. Nos. 6,226,307, 6,020,723, 6,005,880, 5,729,562, 5,914,974, 5,936,988, 5,940,421, and 5,982,800, and U.S. patent application Ser. Nos. 09/922,222, 60/359,181, 09/640,595, 09/791,430, 09/858,147, and 09/838,715, which are assigned to the same assignee as the present application, each of which are hereby incorporated by reference. In particular, a pair of main discharge electrodes and one or more preionization electrodes are connected to the discharge circuit 730, 760 and are located within the oscillator laser tube 720, 780.

The discharge circuit 730, 760 of each laser module 1,2 is connected to an all solid state switch 740 in the embodiment of FIG. 6A preferably including preferably multiple parallel and/or series IGBTs, as described in more detail at the Ser. No. 09/858,147 application, incorporated by reference above. When the switch 740 is triggered, a high voltage 750 is applied to the discharge circuit 730 and/or 760 i.e., either at the same time or alternatively, for energizing the gas mixture in the laser tube 720, 780 for generating a line-narrowed output pulse. The same high voltage power supply may be used for supplying electrical energy to each discharge circuit 730, 760 or each discharge circuit 730, 760 may be supplied with electrical energy from its own power supply, e.g, see FIG. 6B and description below. The linewidth of the line narrowed output pulses from the laser modules 1 and 2 may be as small as 0.1-0.3 pm or less, and is preferably less than 1 pm, and more preferably less than 0.6 pm when used for microlithography, wherein such narrow bandwidth specifications may be relaxed in other industrial applications.

When the switch 740 is triggered, a same power supply is used to provide electrical energy to each laser module 1, 2 and it is desired to temporally space the pulses from the two lasers in the combined laser, the discharge circuit 760 of laser module 1 has the high voltage 750 applied to it preferably through a delay circuit 770, whereas no such delay circuit is included between the switch 740 and the discharge circuit 730 of laser module 2, or a different delay may be applied between the switch 740 and laser module 2 than the delay 770 for laser module 1. Alternatively, the switch may alternatively feed the discharge circuit 730 and the discharge circuit 760, and then the delay may be used for fine temporal adjustments, or to provide delay so that the beam would then be overlapped, if desired, or the delay 770 may be left out altogether. The delay circuit 770 may use a saturable core such as that set forth in U.S. Pat. No. 6,005,880, which is incorporated herein by reference or a choke or other means for delaying the pulse as understood by those skilled in the art. The discharge circuit 760 of laser module 1 is preferably otherwise configured the same as the discharge circuit 730 of laser module 2. The resonators and laser tubes 720, 780 of the two lasers 1, 2 are preferably also the same. For example, the main and preionization electrodes may be the same and the gas mixtures may substantially be the same, and also, connected through a processor and gas supply system as set forth above with respect to the oscillator laser tube described with reference to FIG. 7 herein.

FIG. 6B schematically illustrates an alternate discharge circuit arrangement in accordance with a variation of the configuration shown in FIG. 6A. Like parts as that shown in FIG. 6A are so labeled and thus, a redundant description is omitted here. In contrast with the embodiment shown in FIG. 6A, the two oscillator combination laser design shown in FIG. 6B includes two solid state or thyratron switches 810, 820 which are used instead of the one solid state switch 740 of the embodiment shown in FIG. 6A. Recall that one solid-state switch preferably includes multiple solid state devices, particularly preferably IGBTs, although thyristors may also be used to switch excimer or molecular fluorine lasers.

As shown, the trigger pulse is split and a first current path to the switch 820 of the laser module 2 does not include a delay circuit 830, while a second current path to the switch 810 of the laser module 1 does includes a delay circuit 830 (or different delays or same delays may be provided depending on the degree of temporal separation of overlap of the combined pulses that is desired). The first current path leads to the first solid state switch 820 which permits a high voltage to be applied to the discharge circuit 730 of the laser module 2. The second current path leads to the second switch 810, but does not trigger the switch 810 until a short time period after the trigger pulse triggers the first switch 820, according to the exemplary embodiment schematically illustrated at FIG. 6B. For example, if the delay circuit 830 includes a saturable core, then the delay circuit 830 would depend on the bias applied across the core and the physical characteristics of the core. Further information on the saturable core and its physical characteristics can be found in U.S. Pat. No. 6,005,880 referenced above.

The demand for increasing throughput of microsteppers in semiconductor-chip manufacturing leads to a desire for higher average power output of DUV and VUV excimer and molecular fluorine lasers. The combination of the outputs of multiple discharge units in accord with preferred embodiments serves to increase the output power of the system. In comparison to a Master Oscillator/Power Amplifier (MOPA) approach, the preferred embodiments for combining the multiple beams into a single combined beam have several advantages including first, that the preferred system requires less precise temporal synchronization of the discharge chambers to each other. Since imprecise synchronization in the MOPA systems causes random variations of the effective gain of the amplifier, the pulse energy fluctuations in the proposed system are reduced compared to MOPA. In other words, greater energy stability is achieved according to the preferred embodiments. Second, the combination of two or more discharge units according to preferred embodiments are less problematic as not being troubled by the alignment and gain saturation problems inherent to MOPA systems. Third, the increase in the output power may be gained by increasing the effective repetition rate of the combined beam of output pulses and alternatively by overlapping pulses and increasing single pulse energies, whereas a MOPA system only increases single pulse energies. Increasing the power by increasing the repetition rate as opposed to increasing pulse energies has at least the advantage that increased pulse energies can have negative effects on the optics associated with high pulse peak power.

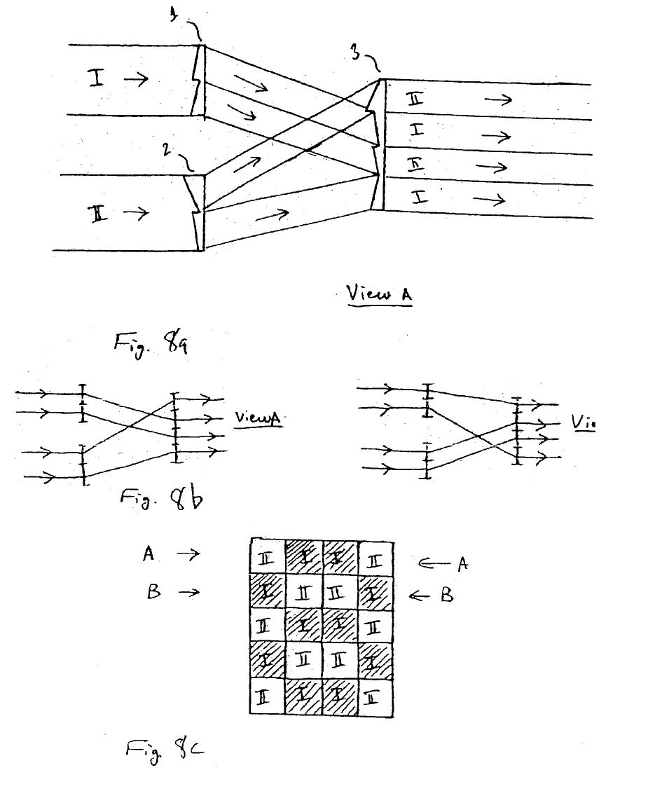

There are several additional embodiments. When combining two or more beams, it is desirable for the optical system downstream of the laser (such as illuminator in a stepper for microlithography) that each beam enters such an optical system symmetrically with respect to the optical axis of the system. In other words, intensity distribution of each beam has to be symmetrical with respect to a common axis, propagation vectors of all beams have to be parallel, however, intensity distributions don't have to be necessarily equal to each other. The embodiments shown in FIGS. 7a-7c and 8a-8c illustrate possible implementations of such concept.

In the embodiment in FIG. 7a, one beam 1 (from the discharge chamber number II) having intensity distribution 5, is split in two halves using highly reflective mirror 2 with straight and sharp edge (“scraper mirror”). Mirror 3 is a conventional highly reflective mirror, it simply reflects remaining half of the beam. Both halves are reflected upwards, where they are reflected again by a pair of similar scraper mirrors 2, in such a way that both halves propagate collinearly and side-by-side with the beam from the chamber number I. The resulting intensity distribution 6 of the output beam 4 is twice as wide as a single beam, it is symmetrical with respect to the geometrical center of the beam, and also both portions of the beam originated from beams I and II are symmetrical with respect to the same geometrical center.

FIGS. 7b and 7c show two possible ways of combining two beam, by splitting each along the vertical or, alternatively, horizontal axis. It is easy to se also that more than two beams can be combined using a similar principle. Also, variety of other mirror arrangements are possible to implement this concept.

FIGS. 8a-8c shows another embodiment that allows to mix beams symmetrically with respect to the optical axis of the system. Here, each beam is effectively split in multitude of small rectangular sections by refractive masks 1 and 2. Each mask is a set of prisms, or wedges, each one having a certain vertex angle. These angles are designed in such a way that refracted portions of the beams propagate at different angles. When they arrive to the third refractive mask 3, these portions are intermixed in a symmetrical pattern, such as that shown in FIG. 8c. The mask 3 refracts each portion of the beam so as to essentially restore original propagation direction of each beam, i.e., collinearly with the optical axis of the system. FIG. 8b shows beam paths in cross-sections A and B of the resulting pattern. FIG. 8c is a “map” of the resulting pattern. Note that each beams contribution to the resulting pattern is symmetrical with respect to the center of the intensity distribution.

In this example, we selected 4 by 5 array of refractive elements, only for illustrative purposes. The number of elements is not limited to 4 by 5. Also, beam paths could be arranged in a multitude of different ways, as long as the resulting pattern is symmetrical. Multiple beams can be combined in a similar fashion. Other than rectangular sections can be used, for example, hexagonal. Furthermore, both or one of the masks can be made as a reflective mask, rather than transmissive.

Additionally, masks 1,2 and 3 maybe constructed of wedged lenses instead of prisms. In this case, masks 1,2 have to be spaced off the mask 3 by the distance approximately equal to the sum of focal length F1 of the masks 1 and 2, and focal length F2 of the mask 3. Thus, beam sections will be focused midway between the masks, and then re-collimated by the mask 3. Also, if F1 and F2 are unequal, this setup can be used for magnification or de-magnification of the beam. Additionally, the lenses may be cylindrical lenses, in order to adjust aspect ratio of the resulting beam.

Furthermore, masks 1,2 and 3 can be made as diffractive masks, rather than refractive. The main principle of symmetrical intermixing of the beams remains the same. In this case, each section is a diffraction grating (well known in the art) designed for required diffraction angle. Such grating can be either reflective or transmissive.

Additional consideration is the temporal synchronization of the pulses from different discharge chambers. In applications like microlithography, the response of the photoresist is usually a function of the total dose of laser radiation, or total amount of incident energy per unit of surface area. Therefore, system's production throughput is dependent on the average power of the laser. Since lower peak intensity of the laser beam leads to reduced degradation of the optical elements, it is generally preferred to have higher repetition rate pulses at a lower pulse energy, rather than higher pulse energy at a lower pulse rate. Therefore, it is logical to synchronize discharge chambers in such a way that pulse trains are interleaved, effectively doubling repetition rate in case of two chambers, for example. However, if there are any effects in the photoresist that favor higher peak power, discharge chambers can be electronically synchronized to overlap pulses in time. More exactly, pulses have to be delayed with respect to each other by no more than the characteristic response time of the photoresist to the laser radiation.

Note also that since output of each chamber is completely incoherent with respect to the other, there is no interference of pulses from different chambers, and the only effect of temporal overlap of the pulses is increased intensity. Intensity in case of exact overlap is the arithmetic sum of intensities of each pulse. This explains why beams have to be mixed in a symmetrical fashion, even in the case of exact temporal overlap. Due to mutual incoherence of the beams, each of them has to be treated as a separate source forming the image on the photoresist. Therefore, effects caused by off-axis propagation through the imaging lens exist in each beam, and then added to each other in the image plane. Some of these effects might have been mutually cancelled in the case of coherent (or partially coherent) and symmetrical beam.

### OVERALL LASER MODULE SYSTEMS

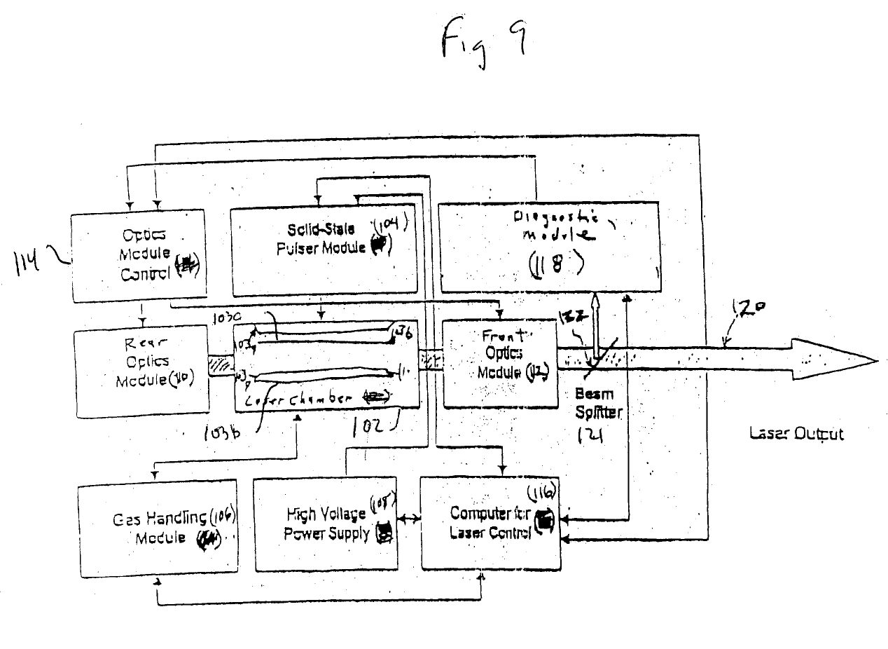

FIG. 9 schematically illustrates an overall excimer or molecular fluorine laser system according to a preferred embodiment of each of the laser modules 1 and 2 of FIG. 1a. As described above, the output beams of two or more of these preferred laser modules 1, 2 are combined to form a single beam of higher power. Referring to FIG. 9, a preferred excimer or molecular fluorine laser system is a DUV or VUV laser system, such as a XeCl, KrF, ArF or molecular fluorine (F₂) laser system, for use with a deep ultraviolet (DUV) or vacuum ultraviolet (VUV) lithography system. It is noted, however, that the beam combiner of this invention may be used to combine two EUV lithography beams, as well. Alternative configurations for laser systems for use in such other industrial applications as TFT annealing, photoablation and/or micromachining, e.g., include configurations understood by those skilled in the art as being similar to and/or modified from the system shown in FIG. 9 to meet the requirements of that application. For this purpose, alternative DUV or VUV laser system and component configurations are described at U.S. patent application Ser. Nos. 09/317,695, 09/244,554, 09/452,353, 09/512,417, 09/599,130, 09/694,246, 09/712,877, 09/574,921, 09/738,849, 09/718,809, 09/629,256, 09/712,367, 09/771,366, 09/715,803, 09/738,849, 09/791,431, 60/204,095, 09/741,465, 09/574,921, 09/734,459, 09/741,465, 09/686,483, 09/584,420, 09/843,604, 09/780,120, 09/792,622, 09/791,431, 09/811,354, 09/838,715, 09/715,803, 09/717,757, 09/771,013, 09/791,430, 09/712,367 and 09/780,124, and U.S. Pat. Nos. 6,285,701, 6,005,880, 6,061,382, 6,020,723, 6,219,368, 6,212,214, 6,154,470, 6,157,662, 6,243,405, 6,243,406, 6,198,761, 5,946,337, 6,014,206, 6,157,662, 6,154,470, 6,160,831, 6,160,832, 5,559,816, 4,611,270, 5,761,236, 6,212,214, 6,243,405, 6,154,470, and 6,157,662, each of which is assigned to the same assignee as the present application and is hereby incorporated by reference.

### DISCHARGE TUBE

The system shown in FIG. 9 generally includes a laser chamber 102 (or laser tube including a heat exchanger and fan for circulating a gas mixture within the chamber 102 or tube) having a pair of main discharge electrodes 103a and one or more preionization units 103b each connected with a solid-state pulser module 104, and a gas handling module 106. The gas handling module 106 has a valve connection to the laser chamber 102 so that halogen, any active rare gases and a buffer gas or buffer gases, and optionally a gas additive, may be injected or filled into the laser chamber, preferably in premixed forms (see U.S. patent application Ser. Nos. 09/513,025, 09/780,120, 09/734,459 and 09/447,882, which are assigned to the same assignee as the present application, and U.S. Pat. Nos. 4,977,573, 4,393,505 and 6,157,662, which are each hereby incorporated by reference. The solid-state pulser module 104 is powered by a high voltage power supply 108. A thyratron pulser module may alternatively be used. The laser chamber 102 is surrounded by optics module 110 and optics module 112, forming a resonator. The optics modules 110 and 112 may be controlled by an optics control module 114, or may be alternatively directly controlled by a computer or processor 116, particular when line-narrowing optics are included in one or both of the optics modules 110, 112, such as is preferred when XeCl, KrF, ArF or F₂ lasers are used for optical lithography.

### PROCESSOR CONTROL

The processor 116 for laser control receives various inputs and controls various operating parameters of the system. A diagnostic module 118 receives and measures one or more parameters, such as pulse energy, average energy and/or power, and preferably wavelength, of a split off portion of the main beam 120 via optics for deflecting a small portion 122 of the beam toward the module 118, such as preferably a beam splitter module 121. As described above, preferably a single processor (e.g., processor 10 of FIG. 1a) is used to control the individual modules according to monitoring performed on the combined beam, such that one energy detector (e.g., detector 9 of FIG. 1a) may be used to monitor the energy of the combined beam (e.g., beam 12 of FIG.1a), one spectrometer (not shown) may be used to monitor the wavelength of the combined beam, etc., while the processor 116, 10 is programmed to sort through pulses that were emitted to the laser module 1 or the laser module 2, so that the processor 116,10 can then control the laser modules 1 and 2 accordingly in feedback arrangements. The output beam is preferably the laser output to an imaging system (not shown) and ultimately to a workpiece (also not shown) such as particularly for lithographic applications, and may be output directly to an application process. The laser control computer 116 may communicate through an interface with a stepper/scanner computer, other control units and/or other external systems.

The processor or control computer 116 receives and processes values of one or more of the pulse shape, energy, ASE, energy stability, energy overshoot for burst mode operation, wavelength, spectral purity and/or bandwidth, among other input or output parameters of the laser system and output beam. The processor may receive signals corresponding to the wavefront compensation such as values of the bandwidth, and may control the wavefront compensation performed by a wavefront compensation optic in a feedback loop by sending signals to adjust the pressure(s) and/or curvature(s) of surfaces associated with the wavefront compensation optic. The processor 116 also controls the line narrowing module to tune the wavelength and/or bandwidth or spectral purity, and controls the power supply and pulser module 104 and 108 to control preferably the moving average pulse power or energy, such that the energy dose at points on the workpiece is stabilized around a desired value. In addition, the computer 116 controls the gas handling module 106 which includes gas supply valves connected to various gas sources. Further functions of the processor 116 such as to provide overshoot control, energy stability control and/or to monitor input energy to the discharge, are described in more detail at U.S. patent application Ser. No. 09/588,561, which is assigned to the same assignee and is hereby incorporated by reference.

As shown in FIG. 9, the processor 116 preferably communicates with the solid-state or thyratron pulser module 104 and HV power supply 108, separately or in combination, the gas handling module 106, the optics modules 110 and/or 112, the diagnostic module 118, and an interface 124. The laser resonator which surrounds the laser chamber 102 containing the laser gas mixture includes optics module 110 including line-narrowing optics for a line narrowed excimer or molecular fluorine laser, which may be replaced by a high reflectivity mirror or the like in a laser system wherein either line-narrowing is not desired, or if line narrowing is performed at the front optics module 112, or a spectral filter external to the resonator is used for narrowing the linewidth of the output beam.

### SOLID STATE PULSER MODULE

The laser chamber 102 contains a laser gas mixture and includes one or more preionization units (not shown) in addition to the pair of main discharge electrodes 103. Preferred main electrodes 103 are described at U.S. patent application Ser. No. 09/453,670 for photolithographic applications, which is assigned to the same assignee as the present application and is hereby incorporated by reference, and may be alternatively configured, e.g., when a narrow discharge width is not preferred. Other electrode configurations are set forth at U.S. Pat. Nos. 5,729,565 and 4,860,300, each of which is assigned to the same assignee, and alternative embodiments are set forth at U.S. Pat. Nos. 4,691,322, 5,535,233 and 5,557,629, all of which are hereby incorporated by reference. Preferred preionization units may be sliding surface or corona-type and are described U.S. patent application Ser. Nos. 09/922,241 and 09/532,276 (sliding surface) and 09/692,265 and 09/247,887 (corona discharge), each of which is assigned to the same assignee as the present application, and additional alternative embodiments are set forth at U.S. Pat. Nos. 5,337,330, 5,818,865, 5,875,207 and 5,991,324, and German Gebraushmuster DE 295 21 572 U1, all of the above patents and patent applications being hereby incorporated by reference.

The solid-state or thyratron pulser module 104 and high voltage power supply 108 supply electrical energy in compressed electrical pulses to the preionization and main electrodes 103 within the laser chamber 102 to energize the gas mixture. Components of the preferred pulser module and high voltage power supply are described above, and further details may be described at U.S. patent application Ser. Nos. 09/640,595, 09/838,715, 60/204,095, 09/432,348 and 09/390,146, and U.S. Pat. Nos. 6,005,880, 6,226,307 and 6,020,723, each of which is assigned to the same assignee as the present application and which is hereby incorporated by reference into the present application. Other alternative pulser modules are described at U.S. Pat. Nos. 5,982,800, 5,982,795, 5,940,421, 5,914,974, 5,949,806, 5,936,988, 6,028,872, 6,151,346 and 5,729,562, each of which is hereby incorporated by reference.

### RESONATOR, GENERAL

The laser resonator which surrounds the laser chamber 102 containing the laser gas mixture includes optics module 110 preferably including line-narrowing optics for a line narrowed excimer or molecular fluorine laser such as for photolithography, which may be replaced by a high reflectivity mirror or the like in a laser system wherein either line-narrowing is not desired (for TFT annealling, e.g.), or if line narrowing is performed at the front optics module 112, or a spectral filter external to the resonator is used, or if the line-narrowing optics are disposed in front of the HR mirror, for narrowing the bandwidth of the output beam. For an F₂-laser, optics for selecting one of multiple lines around 157 nm may be used, e.g., one or more dispersive prisms, birefringent plates or blocks and/or an interferometric device such as an etalon or a device having a pair of opposed, non-parallel plates such as described in the Ser. Nos. 09/715,803 and 60/280,398 applications, wherein the same optic or optics or an additional line-narrowing optic or optics for narrowing the selected line may be used. Also, particularly for the F₂-laser, and also possibly for other excimer lasers, the total gas mixture pressure may be lower than conventional systems, e.g., lower than 3 bar, for producing the selected line at a narrow bandwidth such as 0.5 pm or less without using additional line-narrowing optics (see U.S. patent application Ser. No. 60/212,301, which is assigned to the same assignee as the present application and is hereby incorporated by reference).

The laser chamber 102 is sealed by windows substantially transparent to the wavelengths of the emitted laser radiation 120. The windows may be Brewster windows or may be aligned at another angle, e.g., 5°, to the optical path of the resonating beam. One of the windows may also serve to output couple the beam or as a highly reflective resonator reflector on the opposite side of the chamber 102 as the beam is outcoupled.

### DIAGNOSTIC MODULE

The preferred embodiments with respect to energy monitoring have been described above with reference to FIG. 1a wherein the beam splitter 8 separated a beam portion for input at detector 9, wherein the energy information is sent to processor 10 which controls the high voltage power supply 11 to provide electrical pulses and/or energy dosages at selected energies in a feedback loop. Further parameters of the combined beam may be monitored using a same or different detector and processor (i.e., detector 9 and processor 10 of FIG. 1a). Such further parameters of the combined beam may include wavelength or spectral intensity distribution, bandwidth and/or spectral purity, long and/or short spatial beam profile, beam width and/or divergence, temporal beam profile, amplified spontaneous emission or ASE, spatial or temporal coherence, energy stability, burst overshoot and/or wavelength chirp following a pause in burst mode operation, etc. The processor may then initiate an adjustment of a laser system component such as an orientation or other characteristic of an adjustable tuning optic, a gas replenishment action, a curvature or surface contour of an adjustable optic, e.g., for wavefront compensation (see U.S. Pat. Nos. 6,298,080 and 5,095,492, which are hereby incorporated by reference), a pressure adjustment within any of the laser chamber 102, one of the optics modules 110, 112 or within a housing of an optical component (see, e.g., U.S. patent application Ser. Nos. 09/780,120, 09/960,875, 09/686,483 and 09/657,396, which are assigned to the same assignee as the present application and are hereby incorporated by reference, a replacement of an optical module or component that has aged, etc. The parameter is then continued to be monitored in a feedback arrangement. One or more of these or other parameters may alternatively be monitored in a similar feedback arrangement, provided as information on a display, recorded as information in computer memory for later analysis, etc., by the individual laser modules (i.e., laser modules 1 and 2 of FIG. 1a) themselves. What follows refers to feedback arrangement monitoring for an individual laser module 1 or 2, but it may describe combined beam monitoring according to the system of FIG. 1a according to many variations of the combined system according to a preferred embodiment.

Referring to the individual laser system of FIG. 9 for illustrative purposes (and to corresponding components of FIG. 1a), after a portion of the output beam 120 passes the outcoupler of the optics module 112 of FIG. 9 (or after the beam 12 passes the beam combiner 7 of FIG. 1a), that output portion may impinge upon a beam splitter module 121 (or beam splitter module 8 of FIG. 1a) which includes optics for deflecting a portion 122 of the beam to the diagnostic module 118 (or detector component 9 of FIG. 1a), or otherwise allowing a small portion 122 of the outcoupled beam to reach the diagnostic module 118, while a main beam portion 120 is allowed to continue as the output beam 120 of the laser system (see U.S. patent application Ser. Nos. 09/771,013, 09/598,552, and 09/712,877 which are assigned to the same assignee as the present invention, and U.S. Pat. No. 4,611,270, each of which is hereby incorporated by reference). Preferred optics of the beam splitter module 121 include a beamsplitter or otherwise partially reflecting surface optic. The optics may also include a mirror or beam splitter as a second reflecting optic. More than one beam splitter and/or HR mirror(s), and/or dichroic mirror(s) may be used to direct portions of the beam to components of the diagnostic module 118. A holographic beam sampler, transmission grating, partially transmissive reflection diffraction grating, grism, prism or other refractive, dispersive and/or transmissive optic or optics may also be used to separate a small beam portion from the main beam 120 for detection at the diagnostic module 118, while allowing most of the main beam 120 to reach an application process directly or via an imaging system or otherwise. These optics or additional optics may be used to filter out visible radiation such as the red emission from atomic fluorine in the gas mixture from the split off beam prior to detection.

The output beam 120 may be transmitted at the beam splitter module while a reflected beam portion is directed at the diagnostic module 118, or the main beam 120 may be reflected, while a small portion is transmitted to the diagnostic module 118. The portion of the outcoupled beam that continues past the beam splitter module 121 is the output beam 120 of the laser, which propagates toward an industrial or experimental application such as an imaging system and workpiece for photolithographic applications.

The diagnostic module 118 (and/or detector component 9 of FIG. 1a) preferably includes at least one energy detector as set forth above with reference to FIG. 1a. This detector measures the energy (pulse energy, energy dose, beam power, and/or peak intensity, etc.) of the split-off diagnostic beam portion that corresponds directly to the energy of the output beam 120 (see U.S. Pat. Nos. 4,611,270 and 6,212,214 which are hereby incorporated by reference). An optical configuration such as an optical attenuator, e.g., a plate or a coating, or other optics may be formed on or near the detector to control the intensity, spectral distribution and/or other parameters of the radiation impinging upon the detector (see U.S. patent application Ser. Nos. 09/172,805, 09/741,465, 09/712,877, 09/771,013 and 09/771,366, each of which is assigned to the same assignee as the present application and is hereby incorporated by reference).

One other component of the diagnostic module 118 (and/or detector module 9 of FIG. 1a) is preferably a wavelength and/or bandwidth detection component such as a monitor etalon or grating spectrometer, and a hollow cathode lamp or reference light source for providing absolute wavelength calibration of the monitor etalon or grating spectrometer (see U.S. patent application Ser. Nos. 09/416,344, 09/686,483, and 09/791,431, each of which is assigned to the same assignee as the present application, and U.S. Pat. Nos. 4,905,243, 5,978,391, 5,450,207, 4,926,428, 5,748,346, 5,025,445, 6,160,832, 6,160,831, 6,269,110, 6,272,158 and 5,978,394, all of the above wavelength and/or bandwidth detection and monitoring components being hereby incorporated by reference). The bandwidth and/or wavelength or other spectral, energy or other beam parameter may be monitored and controlled in a feedback loop including the processor 116 and optics control modules 110, 112, gas handling module 106, power supply and pulser modules 103, 104, or other laser system component modules. For example, the total pressure of the gas mixture in the laser tube 102 may be controlled to a particular value for producing an output beam at a particular bandwidth and/or energy. A same or a different beam splitter module may be used as that described above with reference to the energy monitoring loop to split off a diagnostic beam portion 122 from the main beam 120.

Other components of the diagnostic module 118 or 9 may include a pulse shape detector or ASE detector, such as are described at U.S. Pat. Nos. 6,243,405 and 6,243,406 and U.S. patent application Ser. No. 09/842,281, which is assigned to the same assignee as the present application, each of which are hereby incorporated by reference, such as for gas control and/or output beam energy stabilization, or to monitor the amount of amplified spontaneous emission (ASE) within the beam to ensure that the ASE remains below a predetermined level. There may be a beam alignment monitor, e.g., such as is described at U.S. Pat. No. 6,014,206, or beam profile monitor, e.g., U.S. patent application Ser. No. 09/780,124, which is assigned to the same assignee, wherein each of these patent documents is hereby incorporated by reference.

### BEAM PATH ENCLOSURE

Particularly for the molecular fluorine laser system, and also for the ArF and KrF laser systems, an enclosure (not shown) preferably seals the beam path of the beam 120 such as to keep the beam path free of photoabsorbing or other contaminant species that can tend to attenuate and/or otherwise disturb the beam such as by providing a varying refractive index along the optical path of the beam. Smaller enclosures preferably seal the beam path between the chamber 102 and the optics modules 110 and 112 and between the beam splitter 122 and the diagnostic module 118 (see the U.S. Pat. Nos. 6,327,290 and 6,345,065 patents and the Ser. No. 09/598,552 application, each having been incorporated by reference above). The optics modules 110 and 112 are maintained in an atmosphere that is sufficiently evacuated or have an inert gas purged atmosphere preferably either at very low pressure or at a slight overpressure. Preferred enclosures are described in detail in U.S. patent application Ser. Nos. 09/598,552, 09/727,600, and 09/131,580, which are assigned to the same assignee and are hereby incorporated by reference, and U.S. Pat. Nos. 6,327,290, 6,345,065, 6,219,368, 5,559,584, 5,221,823, 5,763,855, 5,811,753 and 4,616,908, all of which are hereby incorporated by reference.

### GAS MIXTURE

The laser gas mixture is initially filled into the laser chamber 102 (corresponding to laser chambers 3a, 3b of FIG. 1a) in a process referred to herein as a “new fills”. In such procedure, the laser tube is evacuated of laser gases and contaminants, and re-filled with an ideal gas composition of fresh gas. The gas composition for a very stable excimer or molecular fluorine laser in accord with the preferred embodiment uses helium or neon or a mixture of helium and neon as buffer gas(es), depending on the particular laser being used. Preferred gas compositions are described at U.S. Pat. Nos. 4,393,405, 6,157,162, 6,243,406 and 4,977,573 and U.S. patent application Ser. Nos. 09/513,025, 09/447,882, 09/789,120 and 09/588,561, each of which is assigned to the same assignee and is hereby incorporated by reference into the present application. The concentration of the fluorine in the gas mixture may range from 0.003% to 1.00%, and is preferably around 0.1%. An additional gas additive, such as a rare gas or otherwise, may be added for increased energy stability, overshoot control and/or as an attenuator as described in the Ser. No. 09/513,025 application incorporated by reference above. Specifically, for the F₂-laser, an addition of xenon, krypton and/or argon may be used. The concentration of xenon or argon in the mixture may range from 0.0001% to 0.1%. For an ArF-laser, an addition of xenon or krypton may be used also having a concentration between 0.0001% to 0.1%. For the KrF laser, an addition of xenon or argon may be used also having a concentration between 0.0001% to 0.1%. Gas replenishment actions are described below for gas mixture compositions of systems such as ArF, KrF, and XeCl excimer lasers and molecular fluorine lasers, wherein the ideas set forth herein may be advantageously incorporated into any of these systems, and other gas discharge laser systems.

### GAS REPLENISHMENT

Halogen gas injections, including micro-halogen injections of, e.g., 1-3 milliliters of halogen gas, mixed with, e.g., 20-60 milliliters of buffer gas or a mixture of the halogen gas, the buffer gas and a active rare gas for rare gas-halide excimer lasers, per injection for a total gas volume in the laser tube 102 of, e.g., 100 liters, total pressure adjustments and gas replacement procedures may be performed using the gas handling module 106 preferably including a vacuum pump, a valve network and one or more gas compartments. The gas handling module 106 receives gas via gas lines connected to gas containers, tanks, canisters and/or bottles. Some preferred and alternative gas handling and/or replenishment procedures, other than as specifically described herein (see below), are described at U.S. Pat. Nos. 4,977,573, 6,212,214, 6,243,406, 6,389,052 and 5,396,514 and U.S. patent application Ser. Nos. 09/447,882, 09/513,025 and 09/588,561, each of which is assigned to the same assignee as the present application, and U.S. Pat. Nos. 5,978,406, 6,014,398 and 6,028,880, all of which are hereby incorporated by reference. A xenon gas or other gas additive supply may be included either internal or external to the laser system according to the '025 application, mentioned above.

Total pressure adjustments in the form of releases of gases or reduction of the total pressure within the laser tube 102 may also be performed (see particularly the Ser. No. 09/780,120 application, incorporated by reference above). Total pressure adjustments may be followed by gas composition adjustments if it is determined that, e.g., other than the desired partial pressure of halogen gas is within the laser tube 102 after the total pressure adjustment. Total pressure adjustments may also be performed after gas replenishment actions, and may be performed in combination with smaller adjustments of the driving voltage to the discharge than would be made if no pressure adjustments were performed in combination.

Gas replacement procedures may be performed and may be referred to as partial, mini- or macro-gas replacement operations, or partial new fill operations, depending on the amount of gas replaced, e.g., anywhere from a few milliliters up to 50 liters or more, but less than a new fill, such as are set forth in the Ser. No. 09/734,459 application, incorporated by reference above. As an example, the gas handling unit 106 connected to the laser tube 102 either directly or through an additional valve assembly, such as may include a small compartment for regulating the amount of gas injected (see the '459 application), may include a gas line for injecting a premix A including 1% F₂:99% Ne or other buffer gas such as He, and another gas line for injecting a premix B including 1% rare gas: 99% buffer gas, for a rare gas-halide excimer laser, wherein for a F₂ laser premix B is not used. Another line may be used for injecting a gas additive or gas additive premix, or a gas additive may be added to premix A, premix B or a buffer gas. Another line may be used for total pressure additions or reductions, i.e., for flowing buffer gas into the laser tube or allowing some of the gas mixture in the tube to be released, possibly accompanying halogen injections for maintaining the halogen concentration. Thus, by injecting premix A (and premix B for rare gas-halide excimer lasers) into the tube 102 via the valve assembly, the fluorine concentration in the laser tube 102 may be replenished. Then, a certain amount of gas may be released corresponding to the amount that was injected to maintain the total pressure at a selected level. Additional gas lines and/or valves may be used for injecting additional gas mixtures. New fills, partial and mini gas replacements and gas injection procedures, e.g., enhanced and ordinary micro-halogen injections, such as between 1 milliliter or less and 3-10 milliliters, or more depending on the degree of stability desired, and any and all other gas replenishment actions are initiated and controlled by the processor 116 (or processor 10 of FIG. 1a) which controls valve assemblies of the gas handling unit 106 and the laser tube 102 based on various input information in a feedback loop. These gas replenishment procedures may be used in combination with gas circulation loops and/or window replacement procedures to achieve a laser system having an increased servicing interval for both the gas mixture and the laser tube windows (see U.S. patent application Ser. No. 60/296,947, which is assigned to the same assignee as the present application and is hereby incorporated by reference).

### LINE NARROWING

A general description of the line-narrowing features of embodiments of the laser system particularly for use with photolithographic applications is provided here, followed by a listing of patent and patent applications being incorporated by reference as describing variations and features that may be used within the scope of the preferred embodiments herein for providing an output beam with a high spectral purity or bandwidth (e.g., below 1 pm and preferably 0.6 pm or less). These exemplary embodiments may be used along with a wavefront compensating optic or optics (see, e.g., U.S. patent application Ser. No. 09/960,875, which is assigned to the same assignee as the present application, and U.S. Pat. Nos. 6,061,382, 6,298,080 and 5,095,492, which are each hereby incorporated by reference). For the F₂ laser, the optics may be used for selecting the primary line λ₁ only of multiple lines around 157 nm, or may be used to provide additional line narrowing as well as performing line-selection, or the resonator may include optics for line-selection and additional optics for line-narrowing of the selected line, and line-narrowing may be provided by controlling (i.e., reducing) the total pressure (see U.S. patent application Ser. No. 60/212,301, which is assigned to the same assignee and is hereby incorporated by reference). Line-narrowing of the broadband emission of the ArF and/or KrF lasers may be as set forth below.

Exemplary line-narrowing optics contained in the optics module 110 include a beam expander, an optional interferometric device such as an etalon or a device having a pair of opposed non-planar reflection plates such as may be described in U.S. patent application Ser. Nos. 09/715,803 or 10/081,883, which are assigned to the same assignee as the present application and are hereby incorporated by reference, and a diffraction grating, and alternatively one or more dispersion prisms may be used, wherein the grating would produce a relatively higher degree of dispersion than the prisms although generally exhibiting somewhat lower efficiency than the dispersion prism or prisms, for a narrow band laser such as is used with a refractive or catadioptric optical lithography imaging system. As mentioned above, the front optics module may include line-narrowing optics such as may be described in any of the Ser. Nos. 09/715,803, 09/738,849, and 09/718,809 applications, each being assigned to the same assignee and hereby incorporated by reference.

Instead of having a retro-reflective grating in the rear optics module 110, the grating may be replaced with a highly reflective mirror, and a lower degree of dispersion may be produced by a dispersive prism, or a beam expander and an interferometric device such as an etalon or device having non-planar opposed plates may be used for line-selection and narrowing, or alternatively no line-narrowing or line-selection may be performed in the rear optics module 110. In the case of using an all-reflective imaging system, the laser may be configured for semi-narrow band operation such as having an output beam linewidth in excess of 0.5 pm, depending on the characteristic broadband bandwidth of the laser, such that additional line-narrowing of the selected line would not be used, either provided by optics or by reducing the total pressure in the laser tube.

The beam expander of the above exemplary line-narrowing optics of the optics module 110 preferably includes one or more prisms. The beam expander may include other beam expanding optics such as a lens assembly or a converging/diverging lens pair. The grating or a highly reflective mirror is preferably rotatable so that the wavelengths reflected into the acceptance angle of the resonator can be selected or tuned. Alternatively, the grating, or other optic or optics, or the entire line-narrowing module may be pressure tuned, such as is set forth in the Ser. No. 09/771,366 application and the U.S. Pat. No. 6,154,470 patent, each of which is assigned to the same assignee and is hereby incorporated by reference. The grating may be used both for dispersing the beam for achieving narrow bandwidths and also preferably for retroreflecting the beam back toward the laser tube. Alternatively, a highly reflective mirror is positioned after the grating which receives a reflection from the grating and reflects the beam back toward the grating in a Littman configuration, or the grating may be a transmission grating. One or more dispersive prisms may also be used, and more than one etalon or other interferometric device may be used.

Depending on the type and extent of line-narrowing and/or selection and tuning that is desired, and the particular laser that the line-narrowing optics are to be installed into, there are many alternative optical configurations that may be used. For this purpose, those shown in U.S. Pat. Nos. 4,399,540, 4,905,243, 5,226,050, 5,559,816, 5,659,419, 5,663,973, 5,761,236, 6,081,542, 6,061,382, 6,154,470, 5,946,337, 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, 5,970,082, 5,978,409, 5,999,318, 5,150,370 and 4,829,536, and German patent DE 298 22 090.3, and any of the patent applications mentioned above and below herein, may be consulted to obtain a line-narrowing configuration that may be used with a preferred laser system herein, and each of these patent references is each hereby incorporated by reference into the present application.

### ADDITIONAL LASER SYSTEM FEATURES

Optics module 112 preferably includes means for outcoupling the beam 120, such as a partially reflective resonator reflector. The beam 120 may be otherwise outcoupled such as by an intra-resonator beam splitter or partially reflecting surface of another optical element, and the optics module 112 would in this case include a highly reflective mirror. The optics control module 114 preferably controls the optics modules 110 and 112 such as by receiving and interpreting signals from the processor 116, and initiating realignment, gas pressure adjustments in the modules 110,112, or reconfiguration procedures (see U.S. Pat. Nos. 6,298,080,6,345,065, 6,285,701, 6,154,470, and U.S. patent application Ser. No. 09/244,554, which is assigned to the same assignee as the present application, each being hereby incorporated by reference).

The halogen concentration in the gas mixture is maintained constant during laser operation by gas replenishment actions by replenishing the amount of halogen in the laser tube for the preferred excimer or molecular fluorine laser herein, such that these gases are maintained in a same predetermined ratio as are in the laser tube 102 following a new fill procedure. In addition, gas injection actions such as μHIs as understood from the '882 application, mentioned above, may be advantageously modified into micro gas replacement procedures, such that the increase in energy of the output laser beam may be compensated by reducing the total pressure. In addition, the laser system is preferably configured for controlling the input driving voltage so that the energy of the output beam is at the predetermined desired energy. The driving voltage is preferably maintained within a small range around HVₒₚₜ, while the gas procedure operates to replenish the gases and maintain the average pulse energy or energy dose, such as by controlling an output rate of change of the gas mixture or a rate of gas flow through the laser tube 102. Advantageously, the gas procedures set forth herein permit the laser system to operate within a very small range around HVₒₚₜ, while still achieving average pulse energy control and gas replenishment, and increasing the gas mixture lifetime or time between new fills (see '120 application, already incorporated by reference above).

In all of the above and below embodiments, the material used for any dispersive prisms, the prisms of any beam expanders, etalons or other interferometric devices, laser windows and the outcoupler is preferably one that is highly transparent at excimer or molecular fluorine laser wavelengths such as 308 for the XeCl laser, 248 nm for the KrF laser, 193 nm for the ArF laser and 157 nm for the F₂ laser. The materials are also capable of withstanding long-term exposure to ultraviolet light with minimal degradation effects. Examples of such materials are CaF₂, MgF₂, BaF₂, LiF, LiSAF, LiCAF, SrF₂, in some cases high purity quartz, fluorine-doped quartz and/or substantially OH-free fused silica. Also, in all of the embodiments, many optical surfaces, particularly those of the prisms, may or may not have an anti-reflective coating on one or more optical surfaces, in order to minimize reflection losses and prolong their lifetime.

Also, the gas composition for the excimer or molecular fluorine laser in the above configurations uses either helium, neon, or a mixture of helium and neon as a buffer gas. For rare gas-halide excimer lasers, the rare gas is preferably maintained at a concentration of around 1.0% in the gas mixture. The concentration of fluorine in the gas mixture preferably ranges from 0.003% to around 1.0%, and is preferably around 0.1%. However, if the total pressure is reduced for narrowing the bandwidth, then the fluorine concentration may be higher than 0.1%, such as may be maintained between 1 and 7 mbar, and more preferably around 3-5 mbar, notwithstanding the total pressure in the tube or the percentage concentration of the halogen in the gas mixture. The addition of a trace amount of xenon, and/or argon, and/or oxygen, and/or krypton and/or other gases (see the '025 application) may be used for increasing the energy stability, burst control, and/or output energy of the laser beam. The concentration of xenon, argon, oxygen, or krypton in the mixture as a gas additive may range from 0.0001% to 0.1%, and would be preferably significantly below 0.1%. Some alternative gas configurations including trace gas additives are set forth at U.S. patent application Ser. No. 09/513,025 and U.S. Pat. No.6,157,662, each of which is assigned to the same assignee and is hereby incorporated by reference.

A line-narrowed oscillator (e.g., laser module 1 and/or laser module 2 of FIG. 1a before beam combination at beam combiner 7) as set forth above, or a combination of beams produced by multiple oscillators (e.g., the combined beam after beam combiner 7 of FIG. 1a), may be followed by a power amplifier for increasing the power of the beam or beams output by the oscillators 1 and 2 before or after beam combination. Preferred features of the oscillator-amplifier set-up are set forth at U.S. Pat. No. 6,381,256 and U.S. patent application Ser. Nos. 60/309,939 and 60/228,184, which are assigned to the same assignee, each of which is hereby incorporated by reference. The amplifier may be the same or a separate discharge chamber 102 when amplification is to occur before beam combination and is preferably a separate discharge chamber when amplification is to occur after the beam combiner 7 of FIG. 1a, although one or both of the chambers 3a, 3b may be used for the additional function of providing amplification (see, e.g., U.S. Pat. Nos. 6,381,256 and references cited therein, 6,381,257, 6,370,174 and 6,359,922, which are hereby incorporated by reference). An optical or electrical delay may be used to time the electrical discharge at the amplifier with the reaching of the optical pulse from the oscillator at the amplifier (see U.S. Pat. No. 6,389,045 and U.S. patent application Ser. Nos. 09/858,147 and 09/922,222, which are assigned to the same assignee as the present application, each of which is hereby incorporated by reference). With particular respect to the F₂-laser, a molecular fluorine laser oscillator may have an advantageous output coupler having a transmission interference maximum at λ₁ and a minimum at λ₂. A 157 nm beam is output from the output coupler and is incident at the amplifier of this embodiment to increase the power of the beam. Thus, a very narrow bandwidth beam is achieved with high suppression of the secondary line λ₂ and high power (at least several Watts to more than 10 Watts).

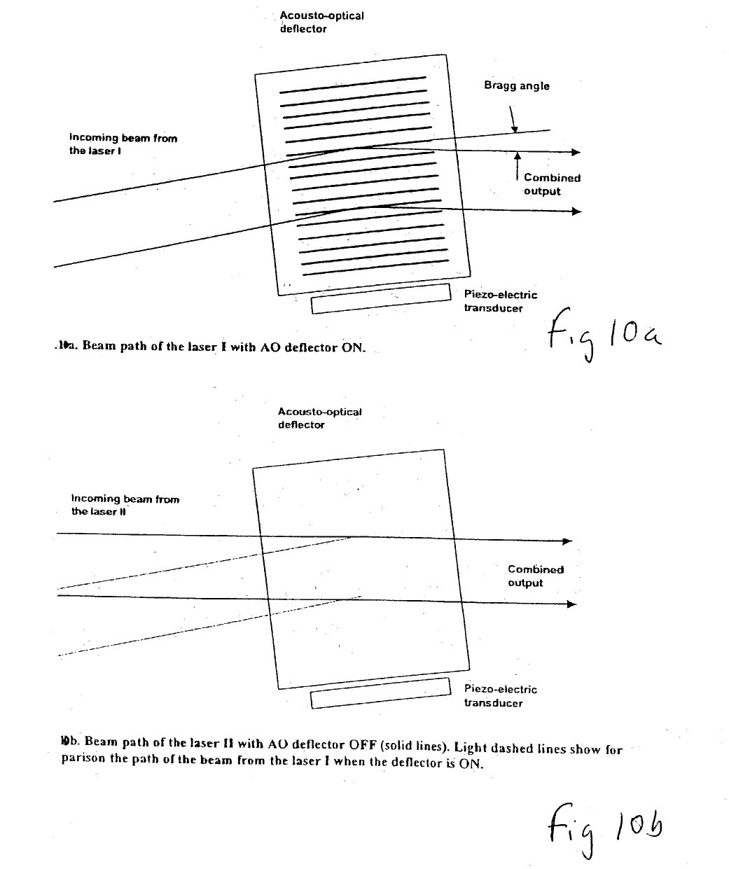

The preferred embodiment of FIG. 1b of the main application includes an optical scanner for interleaving the pulse trains from two lasers. An alternative embodiment is schematically illustrated at FIGS. 10a-10b, wherein the alternative embodiment has the advantage that the laser pulses do not have to be synchronized to the rotation of a scanner wheel. In some applications, it is desired to be able to fire laser pulses by an external trigger. In this case, means to adjust the beam-combining optics “on demand”, i.e., when the trigger signal is received, would be advantageous. Given an exemplary pulse repetition rate of up to 4 kHz from each laser (total of 8 kHz combined), this task includes a fast-response optical component. Such component can be an Acousto-Optical (AO) deflector as illustrated at FIGS. 10a-10b. FIGS. 10a-10b show the operating principle of such beam combiner. AO deflector includes a transparent or at least partially transparent media with piezo-electric transducer attached to one side. Transducer is excited at high frequency (typically from 20 MHZ to 200 MHz) to produce an acoustic wave in the media. The acoustic wave induces modulation of the refractive index in the media in a form of sinusoidal-profile volume grating. The optical beam diffracts on this grating when Bragg's condition is satisfied:

Θ=Θ_{B},

sin(Θ_{B})=λ/(2Λ), (1)

where Θ is the incidence angle, k is the optical wavelength, Θ_{B} is the Bragg angle, Λ is the grating period.

The idea is that the first laser emits pulse (which can be triggered externally) when deflector is on. Then, the beam is reflected off the grating (FIG. 10a). The deflector is switched off right after the pulse from the first lasers passes. The second laser is triggered at approximately half-period delay with respect to the first laser. Since AO deflector is off, the beam from the laser II is not deflected and, therefore, can be aligned precisely along the same beam path as the beam from the laser I (FIG. 10b). The time constant of the AO deflector is typically 100 to 200 nsec per 1 mm of the beam size, which leads to better than 1 microsecond if the beam is 5 mm wide. This allows practically instantaneous switching between On/Off states between the pulses. Diffraction efficiency of AO deflectors in UV optical range is better than 80%. Deflection angle depends on acoustic frequency and optical wavelength, typically it is several mrad. For example, assuming excitation frequency of 200 MHZ, total deflection angle is 6 mrad for 157 nm beam. Acceptance angle is on the order of 1 mrad. For these two reasons, it is advantageous to orient the plane containing deflection angle, along the short axis of the beams.

The AO deflector can be made of any material that is highly transparent for UV and VUV beams when a F₂ or ArF laser is being used as the radiation source: CaF₂, MgF₂, BaF₂, quartz, de-hydrated or fluorinated fused silica, sapphire (particularly for 193 nm), and others. In birefringent materials, such as MgF₂, polarization effects can be used to enhance the diffraction efficiency, for example, by using non-critical phase matching for increased acceptance angle (see I. C. Chang, Acousto-Optic Devices and applications. In: Handbook of Optics, Eds. M. Bass, E. W. van Stryland, D. R. Williams, W. L. Wolfe, McGraw-Hill, 1995, v.II, which is hereby incorporated by reference). Advantages of the alternative embodiment of FIG. 10a-10b include that both laser beams may be substantially perfectly collinear, and the lasers can be triggered externally.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention.

1. A sub-310 nm lithography radiation source, comprising:
a first beam generating module for generating a first pulsed beam having a wavelength in the UV spectrum;
a second beam generating module for generating a second pulsed beam having a wavelength in the UV spectrum;
a beam combiner optic for producing a single beam from the first and second pulsed beams;
optics for directing each of the first and second pulsed beams to be incident upon the beam combiner; and
synchronization electronics for temporally controlling spacings of pulses between the first and second pulsed beams.

2. The radiation source of claim 1, wherein the synchronization electronics include a single switch for permitting electrical pulses to flow to each of the first and second modules.

3. The radiation source of claim 2, further comprising a delay circuit between the switch and at least one of the first and second modules.

4. The radiation source of claim 1, wherein the synchronization electronics include first and second switches for permitting electrical pulses to flow to the first and second modules, respectively.

5. The radiation source of claim 4, further comprising a delay circuit between one of the first switch and first module and the second switch and second module.

6. A sub-3109 nm lithography radiation source, comprising:
a first beam generating module for generating a first pulsed beam having a wavelength in the UV spectrum;
a second beam generating module for generating a second pulsed beam having a wavelength in the UV spectrum;
a beam combiner optic for producing a single combined beam from the first and second pulsed beams; and
optics for directing each of the first and second pulsed beams to be incident upon the beam combiner.

7. The radiation source of claim 6, wherein the beam combiner includes an optical scanner.

8. The radiation source of claim 7, wherein the optical scanner includes a rotatable cylinder and multiple high reflectivity facets.

9. The radiation source of claim 6, wherein the beam combiner includes a polarizer for transmitting the first pulsed beam and for reflecting the second pulsed beam.

10. The radiation source of claim 6, wherein the beam combiner includes a bi-prism.

11. The radiation source of claim 6, wherein the beam combiner includes an optic having first and second reflecting surfaces for reflecting the first and second pulsed beams, respectively.

12. The radiation source of claim 11, wherein the single combined beam includes the first and second pulsed beams side-by-side.

13. The radiation source of claim 11, wherein the single combined beam includes the first and second pulsed beams overlapped.

14. The radiation source of claim 6, wherein the first and second pulsed beams are incident on the beam combiner from different directions, and the beam combiner redirects at least one of the first and second beams, such that each of the first and second beams propagates from the beam combiner in substantially a same direction.

15. The radiation source of claim 14, wherein the first and second beams propagate from the beam combiner along a same optical path.

16. The radiation source of claim 14, wherein the beam combiner includes an acousto-optic deflector for redirecting said at least one of the first and second beams.

17. The radiation source of claim 16, wherein the acousto-optic deflector includes a piezo-electric transducer and an at least partially transparent medium.

18. The radiation source of any of claims 6, wherein the first and second beam generating modules are externally triggered.

19. The radiation source of claim 18, further comprising synchronization electronics for temporally controlling spacings of pulses between the first and second pulsed beams.

20. The radiation source of any of claims 6, further comprising synchronization electronics for temporally controlling spacings of pulses between the first and second pulsed beams.

21. The radiation source of claim 20, wherein the synchronization electronics include a single switch for permitting electrical pulses to flow to each of the first and second modules.

22. The radiation source of claim 21, further comprising a delay circuit between the switch and at least one of the first and second modules.

23. The radiation source of claim 20, wherein the synchronization electronics include first and second switches for permitting electrical pulses to flow to the first and second modules, respectively.

24. The radiation source of claim 23, further comprising a delay circuit between one of the first switch and first module and the second switch and second module.
